(19) United States
(12) Patent Application Publication
(10) Pub. No.: US 2023/0108425 A1
(43) Pub. Date: Apr. 6, 2023

(54) IMAGING LENS SYSTEM

(71) Applicant: SAMSUNG ELECTRO-MECHANICS CO., LTD., Suwon-si (KR)

(72) Inventors: You Jin JEONG, Suwon-si (KR); Jae Hyuk HUH, Suwon-si (KR)

(73) Assignee: SAMSUNG ELECTRO-MECHANICS CO., LTD., Suwon-si (KR)

(21) Appl. No.: 17/573,139

(22) Filed: Jan. 11, 2022

(30) Foreign Application Priority Data
Oct. 6, 2021 (KR) 10-2021-0132142

(51) Int. Cl. G02B 13/00; G02B 9/64

(52) U.S. Cl. CPC G02B 13/0045; G02B 9/64

(57) ABSTRACT

An imaging lens system includes: a first lens having a convex image-side surface; a second lens having refractive power; a third lens having refractive power; a fourth lens having refractive power; a fifth lens having refractive power; and a sixth lens having positive refractive power. In the imaging lens system, the first to sixth lenses are sequentially disposed from an object side. In the imaging lens system, TTL/f<0.85 is satisfied, where TTL is a distance from an object-side surface of the first lens to an imaging plane, and f is a focal length of the imaging lens system.

### CROSS-REFERENCE TO RELATED APPLICATION

This application claims the benefit under 35 USC 119(a) of Korean Patent Application No. 10-2021-0132142, filed on Oct. 6, 2021 with the Korean Intellectual Property Office, the entire disclosure of which is incorporated herein by reference for all purposes.

### BACKGROUND

The following description relates to an imaging lens system that may be mounted in a portable electronic device.

A telephoto camera module has a distance from a forwardmost side of the camera module (e.g., an object-side surface of a first lens) to an image sensor longer than that of a wide-angle camera module. In detail, an imaging lens system for the telephoto camera module has a longer TTL (a distance from an object-side surface of the first lens to an imaging plane) as compared to the imaging lens system for the wide-angle camera module. For this reason, it is difficult to mount the telephoto camera module in a portable electronic device and a thinned electronic device that have many spatial restrictions.

### SUMMARY

This Summary is provided to introduce a selection of concepts in simplified form that a re further described below in the Detailed Description. This Summary is not intended to identify key features or essential features of the claimed subject matter, nor is it intended to be used as an aid in determining the scope of the claimed subject matter.

In one general aspect, an imaging lens system includes: a first lens having a convex image-side surface; a second lens having refractive power; a third lens having refractive power; a fourth lens having refractive power; a fifth lens having refractive power; and a sixth lens having positive refractive power, wherein the first lens to the sixth lens are sequentially disposed from an object side, and TTL/f≤0.85 is satisfied, where TTL is a distance from an object-side surface of the first lens to an imaging plane, and f is a focal length of the imaging lens system.

The second lens may have negative refractive power.

The fourth lens may have a convex object-side surface.

The fourth lens may have a concave image-side surface.

The fifth lens may have a convex image-side surface.

The sixth lens may have a convex object-side surface.

The sixth lens may have a convex image-side surface.

The imaging lens system may satisfy 0.3<f1/f<0.5, where f1 is a focal length of the first lens.

The imaging lens system may satisfy −3.0<f4/f<−0.1, where f4 is a focal length of the fourth lens.

The imaging lens system may satisfy 2.4<f/IMG HT<2.8, where IMG HT is a height of the imaging plane.

The imaging lens system may satisfy 0.1<BFL/f<0.25, where BFL is a distance from an image-side surface of the sixth lens to the imaging plane.

In another general aspect, an imaging lens system includes: a first lens, a second lens, a third lens, a fourth lens, a fifth lens, and a sixth lens, sequentially disposed from an object side, wherein TTL/f≤0.85 and 0.30<D34/D45<0.40, where TTL is a distance from an object-side surface of the first lens to an imaging plane, f is a focal length of the imaging lens system, D34 is a distance from an image-side surface of the third lens to an object-side surface of the fourth lens, and D45 is a distance from an image-side surface of the fourth lens to an object-side surface of the fifth lens.

The first lens may have a convex image-side surface.

The sixth lens may have a convex object-side surface.

The imaging lens system may satisfy 0.17<D45/f<0.20.

The imaging lens system may satisfy 0.063<D34/f<0.073.

Other features and aspects will be apparent from the following detailed description, the drawings, and the claims.

### BRIEF DESCRIPTION OF DRAWINGS

FIG. 1 is a block diagram of an imaging lens system according to a first example.

FIG. 2 is an aberration curve of the imaging lens system illustrated in FIG. 1.

FIG. 3 is a block diagram of an imaging lens system according to a second example.

FIG. 4 is an aberration curve of the imaging lens system illustrated in FIG. 3.

FIG. 5 is a block diagram of an imaging lens system according to a third example.

FIG. 6 is an aberration curve of the imaging lens system illustrated in FIG. 5.

FIG. 7 is a block diagram of an imaging lens system according to a fourth example.

FIG. 8 is an aberration curve of the imaging lens system illustrated in FIG. 7.

FIG. 9 is a block diagram of an imaging lens system according to a fifth example.

FIG. 10 is an aberration curve of the imaging lens system illustrated in FIG. 9.

FIG. 11 is a block diagram of an imaging lens system according to a sixth example.

FIG. 12 is an aberration curve of the imaging lens system illustrated in FIG. 11.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

In the following description, a first lens refers to a lens closest to an object (or a subject), and a sixth lens refers to a lens closest to an imaging plane (or an image sensor). In the present specification, a curvature of radius, a thickness, TTL (a distance from an object-side surface of the first lens to an imaging plane), 2ImgHT (a diagonal length of the imaging plane), ImgHT (½ of 2ImgHT), and a focal length of the lens are represented in millimeters (mm).

The thickness of the lens, an interval between the lenses, and the TTL is a distance from an optical axis of the lens. In addition, in an explanation of a shape of each lens, a convex shape on one surface may mean that a paraxial region of the surface is convex, and a concave shape on one surface may mean that a paraxial region of the surface is concave. Therefore, even when one surface of the lens is described as having a convex shape, an edge portion of the lens may be concave. Similarly, even when one surface of the lens is described as having a concave shape, an edge portion of the lens may be convex.

The imaging lens systems described herein may be configured to be mounted in a portable electronic device. For example, the imaging lens system may be mounted in a smartphone, a notebook computer, an augmented reality device, a virtual reality device (VR), a portable game machine, or the like. However, the range and examples of use of the imaging lens system described herein are not limited to the above-described electronic device. For example, the optical imaging system may provide a narrow mounting space, but may be applied to an electronic device requiring high-resolution imaging.

An imaging lens system according to various examples may include a plurality of lenses. For example, the imaging lens system may include a first lens, a second lens, a third lens, a fourth lens, a fifth lens, and a sixth lens, sequentially disposed from an object side.

In the imaging lens system, a length of the imaging lens system (a distance from an object-side surface of the first lens to an imaging plane (TTL)) and a focal length (f) may form a predetermined numerical condition. For example, the imaging lens system may satisfy a conditional expression TTL/f≤0.85.

The imaging lens system according to various examples may include a lens having a convex surface and a lens having positive refractive power. For example, the imaging lens system may include a first lens having a convex image-side surface and a sixth lens having positive refractive power.

An imaging lens system according to various examples may include a plurality of lenses. For example, the imaging lens system may include a first lens, a second lens, a third lens, a fourth lens, a fifth lens, and a sixth lens, sequentially disposed from an object side.

The imaging lens system may satisfy the conditional expression TTL/f≤0.85. The imaging optical system may form a unique relationship in a form of a distance between lenses. For example, an air gap between a third lens and a fourth lens (a distance D34 from an image-side surface of the third lens to an object-side surface of the fourth lens) may be smaller than an air gap between a fourth lens and a fifth lens (a distance from an image-side surface of the fourth lens to an object-side surface of the fifth lens (D45)). As a specific example, D34 and D45 may satisfy a conditional expression 0.30<D34/D45<0.40.

An imaging lens system according to various examples may be configured in a form satisfying at least one of the following conditional expressions. For example, an imaging lens system may include six lenses, and may satisfy two or more of the following conditional expressions. As another example, an imaging lens system may be comprised of six lenses, and may be comprised in a form satisfying all of the following conditional expressions.

TTL/f≤0.85

0.01<D34/TTL<0.15

0.3<f1/f<0.5

−3.0<f4/f<−0.1

25<V1−V2<45

D12/f<0.2

BFL/f<0.25

0.5<D56/D12<10

FOV<45

In the above conditional expressions, TTL is a distance from an object-side surface of the first lens to an imaging plane, f is a focal length of the imaging lens system, f1 is a focal length of the first lens, f4 is a focal length of the fourth lens, V1 is an Abbe number of the first lens, V2 is an Abbe number of the second lens, BFL is a distance from an image-side surface of the sixth lens to an imaging plane, FOV is a field of view of the imaging lens system, D12 is a distance from an image-side surface of the first lens to an object-side surface of the second lens, D34 is a distance from an image-side surface of the third lens to an image-side surface of the fourth lens, and D56 is a distance from an image-side surface of the fifth lens to an object-side surface of the sixth lens.

The imaging lens system according to various examples may satisfy some of the above-described conditional expressions in a more limited form, as follows.

0.70≤TTL/f≤0.85

0<D12/f<0.2

0.1<BFL/f<0.25

An imaging lens system according to various examples may be configured to satisfy at least one of the following conditional expressions. As an example, the imaging lens system may include six lenses, and may satisfy two or more of the following conditional expressions. As another example, an imaging lens system may be comprised of six lenses, and may be configured to satisfy all of the following conditional expressions.

2.40<f/IMG HT<2.80

0.95<D23/D34<1.20

0.30<D34/D45<0.40

0.17<D45/f<0.20

0.063<D34/f<0.073

In the above conditional expressions, IMG HT is a height of an imaging plane, D23 is a distance from an image-side surface of the second lens to an object-side surface of the third lens, and D45 is a distance from an image-side surface of the fourth lens to an object-side surface of the fifth lens.

The imaging lens system according to various examples may include one or more lenses having the following characteristics, if necessary. As an example, the imaging lens system may include one of the first to sixth lenses according to the following characteristics. As another example, the imaging lens system may include one or more of the first to sixth lenses according to the following characteristics. However, the imaging lens system does not necessarily include the lens according to the following features. Hereinafter, characteristics of the first to sixth lenses will be described.

The first lens has refractive power. For example, the first lens may have positive refractive power. The first lens includes a spherical surface or an aspherical surface. For example, both surfaces of the first lens may be aspherical. The first lens may be formed of a material having high light transmittance and excellent workability. For example, the first lens may be formed of a plastic material or a glass material. The first lens may be configured to have a high refractive index. For example, the refractive index of the first lens may be lower than 1.6. As a specific example, the refractive index of the first lens may be greater than 1.52 and lower than 1.57. The first lens may have a predetermined Abbe number. For example, the Abbe number of the first lens may be less than 60. As a specific example, the Abbe number of the first lens may be greater than 52 and lower than 60.

The second lens has refractive power. For example, the second lens may have negative refractive power. The second lens includes a spherical surface or an aspherical surface. For example, both surfaces of the second lens may be aspherical. The second lens may be formed of a material having high light transmittance and excellent workability. For example, the second lens may be formed of a plastic material or a glass material. The second lens may be configured to have a predetermined refractive index. For example, the refractive index of the second lens may be greater than 1.6. As a specific example, the refractive index of the second lens may be greater than 1.65 and lower than 1.69. The second lens may have a predetermined Abbe number. For example, the Abbe number of the second lens may be less than 30. As a specific example, the Abbe number of the second lens may be greater than 16 and lower than 23.

The third lens has refractive power. For example, the third lens may have positive or negative refractive power. The third lens includes a spherical surface or an aspherical surface. For example, both surfaces of the third lens may be aspherical. The third lens may be formed of a material having high light transmittance and excellent workability. For example, the third lens may be formed of a plastic material or a glass material. The third lens may be configured to have a predetermined refractive index. For example, the refractive index of the third lens may be greater than 1.5 and lower than 1.6. The third lens may have a predetermined Abbe number. For example, the Abbe number of the third lens may be greater than 52 and lower than 60.

The fourth lens has refractive power. For example, the fourth lens may have negative refractive power. One surface of the fourth lens may be convex. For example, the fourth lens may have a convex object-side surface. One surface of the fourth lens may be concave. For example, the fourth lens a concave image-side surface. The fourth lens includes a spherical surface or an aspherical surface. For example, both surfaces of the fourth lens may be aspherical. The fourth lens may be formed of a material having high light transmittance and excellent workability. For example, the fourth lens may be formed of a plastic material or a glass material. The fourth lens may be configured to have a predetermined refractive index. For example, the refractive index of the fourth lens may be greater than 1.5 and lower than 1.6. The fourth lens may have a predetermined Abbe number. For example, the Abbe number of the fourth lens may be greater than 30 and lower than 46.

The fifth lens has refractive power. For example, the fifth lens may have negative refractive power. One surface of the fifth lens may be convex. For example, the fifth lens may have a convex image-side surface. The fifth lens includes a spherical surface or an aspherical surface. For example, both surfaces of the fifth lens may be aspherical. An inflection point may be formed on one or both surfaces of the fifth lens. For example, an inflection point may be formed on the object-side surface and the image-side surface of the fifth lens. The fifth lens may be formed of a material having high light transmittance and excellent workability. For example, the fifth lens may be formed of a plastic material or a glass material. The fifth lens may be configured to have a predetermined refractive index. For example, the refractive index of the fifth lens may be greater than 1.5. As a specific example, the refractive index of the fifth lens may be greater than 1.52 and lower than 1.58. The fifth lens may have a predetermined Abbe number. For example, the Abbe number of the fifth lens may be less than 30. As a specific example, the Abbe number of the fifth lens may be greater than 18 and lower than 30.

The sixth lens has refractive power. For example, the sixth lens may have positive refractive power. One surface of the sixth lens may be convex. For example, the sixth lens may have a convex object-side surface. As another aspect, the sixth lens may have a convex image-side surface. The sixth lens includes a spherical surface or an aspherical surface. For example, both surfaces of the sixth lens may be aspherical. An inflection point may be formed on one or both surfaces of the sixth lens. For example, an inflection point may be formed on the object-side surface and the image-side surface of the sixth lens. The sixth lens may be formed of a material having high light transmittance and excellent workability. For example, the sixth lens may be formed of a plastic material or a glass material. The sixth lens may be configured to have a predetermined refractive index. For example, the refractive index of the sixth lens may be lower than 1.7. As a specific example, the refractive index of the sixth lens may be greater than 1.62 and lower than 1.70. The sixth lens may have a predetermined Abbe number. For example, the Abbe number of the sixth lens may be less than 30. As a specific example, the Abbe number of the sixth lens may be greater than 18 and lower than 30.

The first to sixth lenses may include a spherical surface or an aspherical surface as described above. When the first to sixth lenses include an aspherical surface, the aspherical surface of the corresponding lens may be expressed by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} \qquad Equation 1 :$$

In Equation 1, c is a curvature of a lens surface and is equal to a reciprocal of a radius of curvature of the lens surface at an optical axis of the lens surface, K is a conic constant, Y is a distance from any point on the lens surface to the optical axis of the lens surface in a direction perpendicular to the optical axis of the lens surface, A to H are aspheric constants, and Z (also known as sag) is a distance in a direction parallel to the optical axis of the lens surface from the point on the lens surface at the distance Y from the optical axis of the lens surface to a tangential plane perpendicular to the optical axis and intersecting a vertex of the lens surface.

The imaging lens system according to various examples may further include a stop and a filter. For example, the imaging lens system may further include a stop disposed between the third lens and the fourth lens. As another example, the imaging lens system may include a filter disposed between the sixth lens and an imaging plane. The stop may be configured to adjust an amount of light incident in a direction of the imaging plane, and the filter may block light of a specific wavelength. For reference, the filter described herein is configured to block infrared rays, but light of a wavelength that is blocked by the filter is not limited to infrared.

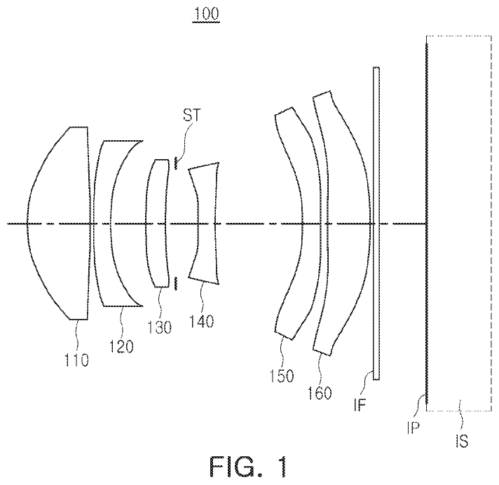

First, an imaging lens system according to a first example will be described with reference to FIG. 1.

An imaging lens system 100 includes a first lens 110, a second lens 120, a third lens 130, a fourth lens 140, a fifth lens 150, and a sixth lens 160.

The first lens 110 has positive refractive power, and has a convex object-side surface and a convex image-side surface. The second lens 120 has negative refractive power, and has a convex object-side surface and a concave image-side surface. The third lens 130 has negative refractive power, and has a convex object-side surface and a concave image-side surface. The fourth lens 140 has negative refractive power, and has a convex object-side surface and a concave image-side surface. The fifth lens 150 has negative refractive power, and has a concave object-side surface and a convex image-side surface. An inflection point is formed on the object-side surface and the image-side surface of the fifth lens 150. The sixth lens 160 has positive refractive power, and has a convex object-side surface and a convex image-side surface. An inflection point is formed on the object-side surface and the image-side surface of the sixth lens 160.

The imaging lens system 100 may further include a stop ST, a filter IF, and an imaging plane IP. The stop ST may be disposed between the third lens 130 and the fourth lens 140, and the filter IF may be disposed between the sixth lens 160 and the imaging plane IP. The imaging plane IP may be formed in a position in which light incident from the first lens 110 to the sixth lens 160 is formed. For example, the imaging plane IP may be formed on one surface of the image sensor IS of the camera module or inside the image sensor IS.

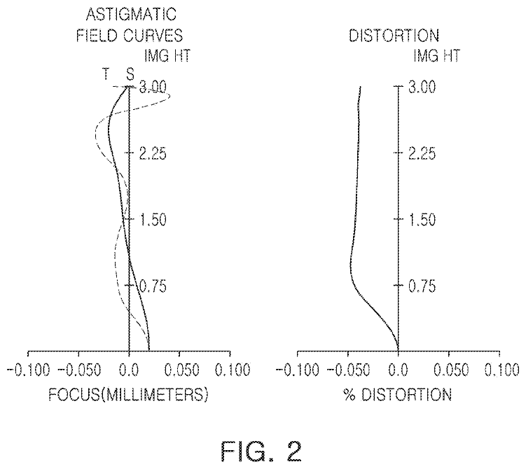

The imaging lens system 100 configured as above may exhibit aberration characteristics as illustrated in FIG. 2. Tables 1 and 2 illustrate lens characteristics and aspheric values of the imaging lens system 100.

TABLE 1

| Surface | | Radius of | Thickness/ | Refractive | Abbe |
|---|---|---|---|---|---|
| No. | Reference | curvature | distance | index | number |
| S1 | First lens | 2.00 | 1.060 | 1.544 | 56.0 |
| S2 | | −12.29 | 0.053 | | |
| S3 | Second lens | 8.47 | 0.280 | 1.661 | 20.4 |
| S4 | | 3.01 | 0.589 | | |
| S5 | Third lens | 6.91 | 0.331 | 1.535 | 55.7 |
| S6 | | 4.67 | 0.177 | | |
| S7 | Stop | Infinity | 0.374 | | |
| S8 | Fourth lens | 23.33 | 0.280 | 1.567 | 37.4 |
| S9 | | 4.07 | 1.472 | | |
| S10 | Fifth lens | −2.63 | 0.300 | 1.544 | 56.0 |
| S11 | | −34.60 | 0.119 | | |
| S12 | Sixth lens | 9.05 | 0.706 | 1.661 | 20.4 |
| S13 | | −11.63 | 0.050 | | |
| S14 | Filter | Infinity | 0.110 | 1.517 | 64.2 |
| S15 | | Infinity | 0.800 | | |
| S16 | Imaging | Infinity | −0.020 | | |
| | plane | | | | |

TABLE 2

| Surface No. | S1 | S2 | S3 | S4 | S5 | S6 |
|---|---|---|---|---|---|---|
| K | −1.409E−01 | −2.071E+01 | 1.752E+01 | 2.735E+00 | −3.494E+00 | −2.390E+01 |
| A | 2.895E−04 | −1.210E−02 | −5.865E−02 | −5.432E−02 | −3.875E−03 | −6.910E−02 |
| B | −1.593E−03 | 9.870E−02 | 1.493E−01 | 9.201E−02 | 8.618E−02 | 1.750E−01 |
| C | 3.179E−04 | −1.937E−01 | −1.923E−01 | 2.950E−02 | 6.190E−02 | −6.551E−01 |
| D | 6.996E−04 | 2.342E−01 | 1.781E−01 | −3.115E−01 | −3.607E−01 | 2.343E+00 |
| E | −2.782E−03 | −1.837E−01 | −9.305E−02 | 7.248E−01 | 7.687E−01 | −5.445E+00 |
| F | 2.762E−03 | 9.246E−02 | 8.757E−03 | −9.182E−01 | −9.769E−01 | 7.709E+00 |
| G | −1.342E−03 | −2.876E−02 | 1.644E−02 | 6.610E−01 | 7.355E−01 | −6.459E+00 |
| H | 3.225E−04 | 5.038E−03 | −8.039E−03 | −2.542E−01 | −2.910E−01 | 2.937E+00 |
| J | −3.077E−05 | −3.806E−04 | 1.175E−03 | 4.034E−02 | 4.170E−02 | −5.626E−01 |
| Surface No. | S8 | S9 | S10 | S11 | S12 | S13 |
| K | −2.500E+01 | 2.881E+00 | −2.500E+01 | −2.500E+01 | 8.980E+00 | 0.000E+00 |
| A | −3.089E−01 | −2.187E−01 | −5.366E−02 | −1.091E−01 | −2.827E−01 | −1.658E−01 |
| B | −6.791E−02 | 1.778E−01 | −5.190E−02 | 3.170E−01 | 5.556E−01 | 1.767E−01 |
| C | 9.242E−01 | −2.013E−01 | 7.182E−02 | −5.026E−01 | −6.303E−01 | −1.128E−01 |
| D | −3.192E+00 | 7.189E−01 | −3.420E−02 | 4.193E−01 | 4.216E−01 | 3.922E−02 |
| E | 7.020E+00 | −1.579E+00 | 5.411E−03 | −2.079E−01 | −1.760E−01 | −6.199E−03 |
| F | −9.803E+00 | 2.209E+00 | 2.336E−03 | 6.375E−02 | 4.669E−02 | −2.246E−04 |
| G | 8.438E+00 | −1.925E+00 | −1.398E−03 | −1.191E−02 | −7.667E−03 | 2.480E−04 |
| H | −4.143E+00 | 9.437E−01 | 2.804E−04 | 1.244E−03 | 7.128E−04 | −3.559E−05 |
| J | 8.884E−01 | −1.982E−01 | −2.065E−05 | −5.560E−05 | −2.877E−05 | 1.696E−06 |

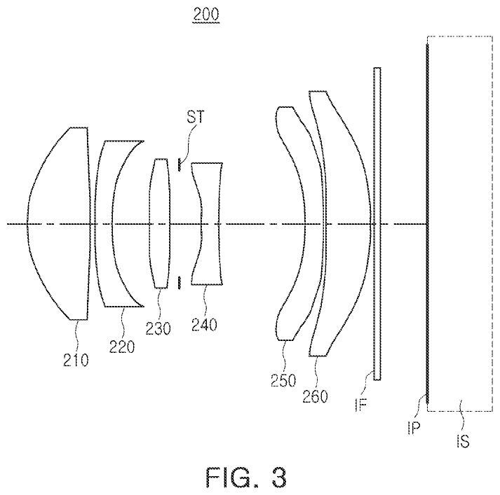

An imaging lens system according to a second example will be described with reference to FIG. 3.

An imaging lens system 200 includes a first lens 210, a second lens 220, a third lens 230, a fourth lens 240, a fifth lens 250, and a sixth lens 260.

The first lens 210 has positive refractive power, and has a convex object-side surface and a convex image-side surface. The second lens 220 has negative refractive power, and has a convex object-side surface and a concave image-side surface. The third lens 230 has positive refractive power, and has a convex object-side surface and a concave image-side surface. The fourth lens 240 has negative refractive power, and has a concave object-side surface and a concave image-side surface. The fifth lens 250 has negative refractive power, and has a concave object-side surface and a convex image-side surface. An inflection point is formed on the object-side surface and the image-side surface of the fifth lens 250. The sixth lens 260 has positive refractive power, and has a convex object-side surface and a convex image-side surface. An inflection point is formed on the object-side surface and the image-side surface of the sixth lens 260.

The imaging lens system 200 may further include a stop ST, a filter IF, and an imaging plane IP. The stop ST may be disposed between the third lens 230 and the fourth lens 240, and the filter IF may be disposed between the sixth lens 260 and the imaging plane IP. The imaging plane IP may be formed in a position in which light incident from the first lens 210 to the sixth lens 260 is formed. For example, the imaging plane IP may be formed on one surface of the image sensor IS of the camera module or inside the image sensor IS.

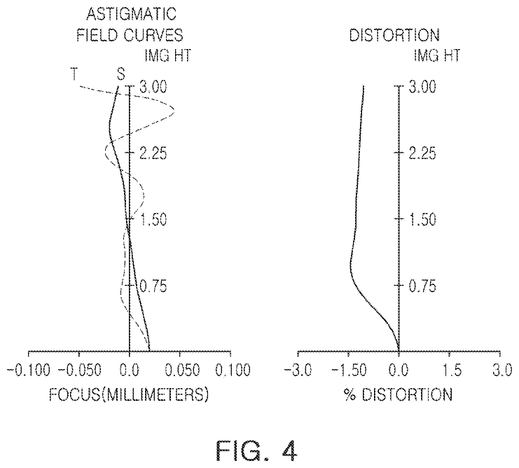

The imaging lens system 200 configured as above may exhibit aberration characteristics as illustrated in FIG. 4. Tables 3 and 4 illustrate lens characteristics and aspheric values of the imaging lens system 200.

TABLE 3

| Surface | | Radius of | Thickness/ | Refractive | Abbe |
|---|---|---|---|---|---|
| No. | Reference | curvature | distance | index | number |
| S1 | First lens | 2.00 | 1.056 | 1.544 | 56.0 |
| S2 | | −12.78 | 0.078 | | |
| S3 | Second lens | 8.83 | 0.280 | 1.661 | 20.4 |
| S4 | | 3.03 | 0.629 | | |
| S5 | Third lens | 146.02 | 0.349 | 1.535 | 55.7 |
| S6 | | 9832.25 | 0.158 | | |
| S7 | Stop | Infinity | 0.367 | | |
| S8 | Fourth lens | −67.55 | 0.280 | 1.567 | 37.4 |
| S9 | | 3.77 | 1.457 | | |
| S10 | Fifth lens | −2.65 | 0.300 | 1.544 | 56.0 |
| S11 | | −35.44 | 0.052 | | |
| S12 | Sixth lens | 11.99 | 0.733 | 1.661 | 20.4 |
| S13 | | −8.21 | 0.050 | | |
| S14 | Filter | Infinity | 0.110 | 1.517 | 64.2 |
| S15 | | Infinity | 0.800 | | |
| S16 | Imaging | Infinity | −0.020 | | |
| | plane | | | | |

TABLE 4

| Surface No. | S1 | S2 | S3 | S4 | S5 | S6 |
|---|---|---|---|---|---|---|
| K | −1.458E−01 | −1.969E+01 | 1.861E+01 | 2.723E+00 | 2.500E+01 | −2.500E+01 |
| A | 2.566E−06 | −1.274E−02 | −6.046E−02 | −5.842E−02 | 1.004E−02 | −7.101E−02 |
| B | −3.982E−03 | 1.030E−01 | 1.580E−01 | 9.185E−02 | 8.628E−02 | 1.757E−01 |
| C | 9.024E−03 | −2.020E−01 | −2.085E−01 | 4.869E−02 | −1.789E−03 | −6.008E−01 |
| D | −1.386E−02 | 2.443E−01 | 2.000E−01 | −3.812E−01 | −1.642E−01 | 2.004E+00 |
| E | 1.107E−02 | −1.917E−01 | −1.112E−01 | 8.753E−01 | 3.669E−01 | −4.541E+00 |
| F | −5.140E−03 | 9.642E−02 | 1.636E−02 | −1.115E+00 | −4.460E−01 | 6.365E+00 |
| G | 1.335E−03 | −2.994E−02 | 1.576E−02 | 8.134E−01 | 3.152E−01 | −5.307E+00 |
| H | −1.754E−04 | 5.227E−03 | −8.579E−03 | −3.182E−01 | −1.150E−01 | 2.402E+00 |
| J | 8.475E−06 | −3.932E−04 | 1.308E−03 | 5.139E−02 | 1.235E−02 | −4.558E−01 |
| Surface No. | S8 | S9 | S10 | S11 | S12 | S13 |
| K | 2.500E+01 | 1.562E+00 | −2.027E+01 | 2.500E+01 | 1.723E+01 | 0.000E+00 |
| A | −3.375E−01 | −2.515E−01 | 6.334E−03 | −1.018E−01 | −2.880E−01 | −1.460E−01 |
| B | 4.075E−02 | 2.962E−01 | −2.629E−01 | 2.070E−01 | 5.383E−01 | 1.357E−01 |
| C | 6.737E−01 | −4.556E−01 | 4.391E−01 | −2.782E−01 | −5.904E−01 | −7.157E−02 |
| D | −2.202E+00 | 1.187E+00 | −4.122E−01 | 2.014E−01 | 3.882E−01 | 1.565E−02 |
| E | 3.720E+00 | −2.285E+00 | 2.435E−01 | −8.735E−02 | −1.607E−01 | 2.159E−03 |
| F | −2.928E+00 | 2.930E+00 | −9.079E−02 | 2.374E−02 | 4.253E−02 | −2.079E−03 |
| G | −9.246E−02 | −2.381E+00 | 2.077E−02 | −4.015E−03 | −7.021E−03 | 4.964E−04 |
| H | 1.653E+00 | 1.108E+00 | −2.670E−03 | 3.914E−04 | 6.620E−04 | −5.388E−05 |
| J | −7.692E−01 | −2.250E−01 | 1.477E−04 | −1.690E−05 | −2.735E−05 | 2.264E−06 |

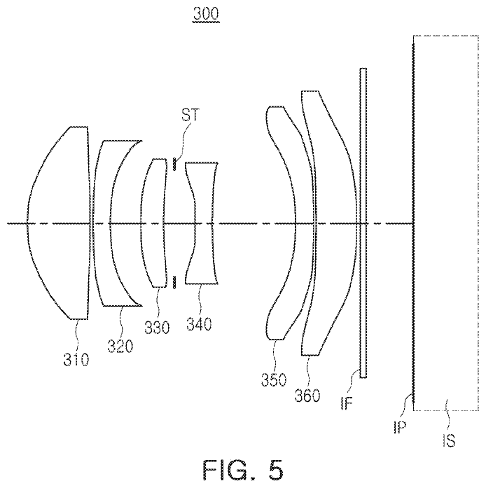

An imaging lens system according to a third example will be described with reference to FIG. 5.

An imaging lens system 300 includes a first lens 310, a second lens 320, a third lens 330, a fourth lens 340, a fifth lens 350, and a sixth lens 360.

The first lens 310 has positive refractive power, and has a convex object-side surface and a convex image-side surface. The second lens 320 has negative refractive power, and has a convex object-side surface and a concave image-side surface. The third lens 330 has negative refractive power, and has a convex object-side surface and a concave image-side surface. The fourth lens 340 has negative refractive power, and has a convex object-side surface and a concave image-side surface. The fifth lens 350 has negative refractive power, and has a concave object-side surface and a convex image-side surface. An inflection point is formed on the object-side surface and the image-side surface of the fifth lens 350. The sixth lens 360 has positive refractive power, and has a convex object-side surface and a convex image-side surface. An inflection point is formed on the object-side surface and the image-side surface of the sixth lens 360.

The imaging lens system 300 may further include a stop ST, a filter IF, and an imaging plane IP. The stop ST may be disposed between the third lens 330 and the fourth lens 340, and the filter IF may be disposed between the sixth lens 360 and the imaging plane IP. The imaging plane IP may be formed in a position in which light incident from the first lens 310 to the sixth lens 360 is formed. For example, the imaging plane IP may be formed on one surface of the image sensor IS of the camera module or inside the image sensor IS.

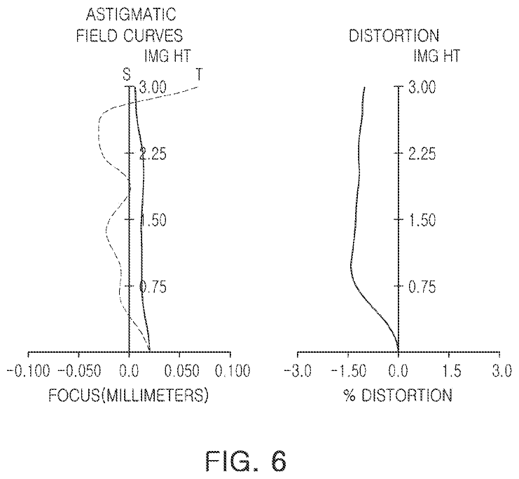

The imaging lens system 300 configured as above may exhibit aberration characteristics as illustrated in FIG. 6. Tables 5 and 6 illustrate lens characteristics and aspheric values of the imaging lens system 300.

TABLE 5

| Surface | | Radius of | Thickness/ | Refractive | Abbe |
|---|---|---|---|---|---|
| No. | Reference | curvature | distance | index | number |
| S1 | First lens | 1.97 | 1.071 | 1.544 | 56.0 |
| S2 | | −12.91 | 0.051 | | |
| S3 | Second lens | 8.58 | 0.280 | 1.661 | 20.4 |
| S4 | | 3.03 | 0.517 | | |
| S5 | Third lens | 4.78 | 0.369 | 1.535 | 55.7 |
| S6 | | 4.18 | 0.190 | | |
| S7 | Stop | Infinity | 0.348 | | |
| S8 | Fourth lens | 84.53 | 0.280 | 1.567 | 37.4 |
| S9 | | 3.54 | 1.396 | | |
| S10 | Fifth lens | −2.58 | 0.300 | 1.544 | 56.0 |
| S11 | | −24.54 | 0.050 | | |
| S12 | Sixth lens | 10.73 | 0.679 | 1.661 | 20.4 |
| S13 | | −23.05 | 0.050 | | |
| S14 | Filter | Infinity | 0.110 | 1.517 | 64.2 |
| S15 | | Infinity | 0.800 | | |
| S16 | Imaging | Infinity | −0.020 | | |
| | plane | | | | |

TABLE 6

| Surface No. | S1 | S2 | S3 | S4 | S5 | S6 |
|---|---|---|---|---|---|---|
| K | −1.474E−01 | −1.842E+01 | 1.683E+01 | 2.775E+00 | −3.293E+00 | −2.500E+01 |
| A | 4.117E−04 | −1.189E−02 | −5.938E−02 | −5.508E−02 | −1.135E−03 | −6.611E−02 |
| B | −4.312E−03 | 9.907E−02 | 1.504E−01 | 9.368E−02 | 7.303E−02 | 2.551E−01 |
| C | 9.111E−03 | −1.946E−01 | −1.925E−01 | 3.714E−02 | 8.222E−02 | −1.301E+00 |
| D | −1.283E−02 | 2.343E−01 | 1.746E−01 | −3.401E−01 | −3.785E−01 | 4.741E+00 |
| E | 9.051E−03 | −1.826E−01 | −8.500E−02 | 7.865E−01 | 7.560E−01 | −1.083E+01 |
| F | −3.420E−03 | 9.101E−02 | −2.616E−04 | −1.000E+00 | −8.939E−01 | 1.524E+01 |
| G | 5.538E−04 | −2.793E−02 | 2.195E−02 | 7.248E−01 | 6.135E−01 | −1.283E+01 |
| H | 8.890E−06 | 4.806E−03 | −9.783E−03 | −2.807E−01 | −2.118E−01 | 5.916E+00 |
| J | −9.474E−06 | −3.552E−04 | 1.399E−03 | 4.483E−02 | 2.222E−02 | −1.151E+00 |
| Surface No. | S8 | S9 | S10 | S11 | S12 | S13 |
| K | −2.500E+01 | 4.455E+00 | −2.500E+01 | 2.500E+01 | 1.603E+01 | 0.000E+00 |
| A | −3.285E−01 | −2.415E−01 | −1.301E−02 | −9.531E−02 | −3.205E−01 | −1.775E−01 |
| B | 1.278E−01 | 4.219E−01 | −2.461E−01 | 2.444E−01 | 6.577E−01 | 1.850E−01 |
| C | −2.129E−01 | −1.605E+00 | 4.238E−01 | −3.816E−01 | −7.836E−01 | −1.165E−01 |
| D | 1.115E+00 | 6.100E+00 | −3.808E−01 | 3.163E−01 | 5.559E−01 | 3.726E−02 |
| E | −3.066E+00 | −1.462E+01 | 2.080E−01 | −1.542E−01 | −2.462E−01 | −3.232E−03 |
| F | 4.476E+00 | 2.193E+01 | −7.069E−02 | 4.557E−02 | 6.892E−02 | −1.590E−03 |
| G | −3.285E+00 | −1.998E+01 | 1.471E−02 | −8.006E−03 | −1.186E−02 | 5.568E−04 |
| H | 8.313E−01 | 1.007E+01 | −1.732E−03 | 7.691E−04 | 1.148E−03 | −7.032E−05 |
| J | 9.753E−02 | −2.155E+00 | 8.897E−05 | −3.110E−05 | −4.788E−05 | 3.243E−06 |

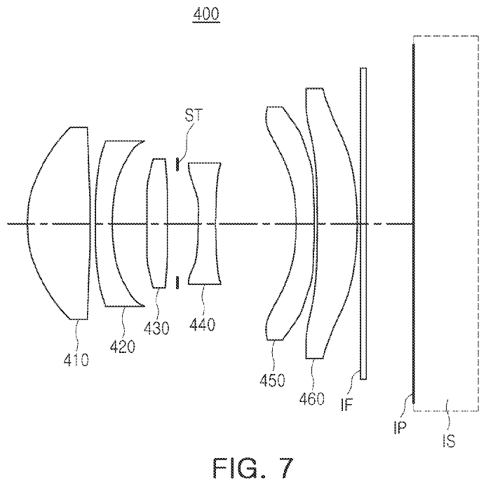

An imaging lens system according to a fourth example will be described with reference to FIG. 7.

An imaging lens system 400 includes a first lens 410, a second lens 420, a third lens 430, a fourth lens 440, a fifth lens 450, and a sixth lens 460.

The first lens 410 has positive refractive power, and has a convex object-side surface and a convex image-side surface. The second lens 420 has negative refractive power, and has a convex object-side surface and a concave image-side surface. The third lens 430 has positive refractive power, and has a convex object-side surface and a concave image-side surface. The fourth lens 440 has negative refractive power, and has a concave object-side surface and a concave image-side surface. The fifth lens 450 has negative refractive power, and has a concave object-side surface and a concave image-side surface. An inflection point is formed on the object-side surface and the image-side surface of the fifth lens 450. The sixth lens 460 has positive refractive power, and has a convex object-side surface and a convex image-side surface. An inflection point is formed on the object-side surface and the image-side surface of the sixth lens 460.

The imaging lens system 400 may further include a stop ST, a filter IF, and an imaging plane IP. The stop ST may be disposed between the third lens 430 and the fourth lens 440, and the filter IF may be disposed between the sixth lens 460 and the imaging plane IP. The imaging plane IP may be formed in a position in which light incident from the first lens 410 to the sixth lens 460 is formed. For example, the imaging plane IP may be formed on one surface of the image sensor IS of the camera module or inside the image sensor IS.

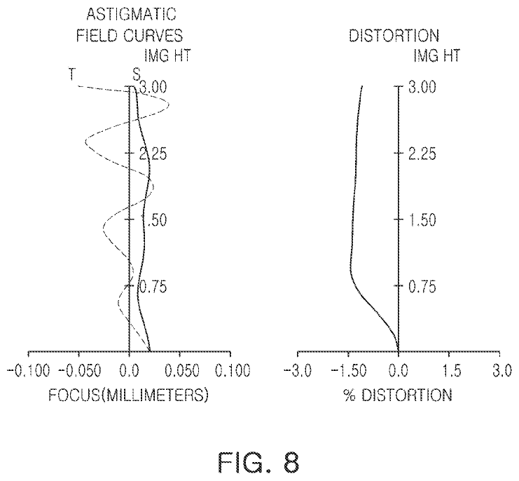

The imaging lens system 400 configured as above may exhibit aberration characteristics as illustrated in FIG. 8. Tables 7 and 8 illustrate lens characteristics and aspheric values of the imaging lens system 400.

TABLE 7

| Surface | | Radius of | Thickness/ | Refractive | Abbe |
|---|---|---|---|---|---|
| No. | Reference | curvature | distance | index | number |
| S1 | First lens | 1.97 | 1.076 | 1.544 | 56.0 |
| S2 | | −12.48 | 0.078 | | |
| S3 | Second lens | 9.06 | 0.280 | 1.661 | 20.4 |
| S4 | | 3.06 | 0.569 | | |
| S5 | Third lens | 19.72 | 0.355 | 1.535 | 55.7 |
| S6 | | 24.00 | 0.169 | | |
| S7 | Stop | Infinity | 0.355 | | |
| S8 | Fourth lens | −95.79 | 0.280 | 1.567 | 37.4 |
| S9 | | 3.42 | 1.350 | | |
| S10 | Fifth lens | −3.24 | 0.300 | 1.544 | 56.0 |
| S11 | | 37.68 | 0.050 | | |
| S12 | Sixth lens | 13.06 | 0.668 | 1.661 | 20.4 |
| S13 | | −20.27 | 0.050 | | |
| S14 | Filter | Infinity | 0.110 | 1.517 | 64.2 |
| S15 | | Infinity | 0.800 | | |
| S16 | Imaging | Infinity | −0.020 | | |
| | plane | | | | |

TABLE 8

| Surface No. | S1 | S2 | S3 | S4 | S5 | S6 |
|---|---|---|---|---|---|---|
| K | −1.477E−01 | −1.890E+01 | 1.765E+01 | 2.798E+00 | 2.500E+01 | −2.500E+01 |
| A | 6.217E−04 | −1.197E−02 | −6.096E−02 | −5.802E−02 | 1.546E−02 | −6.850E−02 |
| B | −8.851E−03 | 9.789E−02 | 1.567E−01 | 9.304E−02 | 7.164E−02 | 2.190E−01 |
| C | 2.271E−02 | −1.884E−01 | −2.045E−01 | 5.513E−02 | 3.287E−02 | −9.216E−01 |
| D | −3.365E−02 | 2.217E−01 | 1.918E−01 | −4.094E−01 | −2.621E−01 | 3.149E+00 |
| E | 2.771E−02 | −1.683E−01 | −1.003E−01 | 9.404E−01 | 6.049E−01 | −7.078E+00 |
| F | −1.353E−02 | 8.143E−02 | 6.882E−03 | −1.205E+00 | −8.281E−01 | 9.895E+00 |
| G | 3.820E−03 | −2.416E−02 | 2.093E−02 | 8.870E−01 | 6.827E−01 | −8.286E+00 |
| H | −5.695E−04 | 4.000E−03 | −1.015E−02 | −3.503E−01 | −3.070E−01 | 3.784E+00 |
| J | 3.371E−05 | −2.832E−04 | 1.511E−03 | 5.713E−02 | 5.397E−02 | −7.249E−01 |
| Surface No. | S8 | S9 | S10 | S11 | S12 | S13 |
| K | 2.500E+01 | 1.890E+00 | −1.665E+01 | −2.500E+01 | 2.500E+01 | 0.000E+00 |
| A | −3.371E−01 | −2.500E−01 | 4.465E−02 | −8.214E−02 | −2.615E−01 | −1.726E−01 |
| B | 2.079E−01 | 3.886E−01 | −4.044E−01 | 6.454E−03 | 4.247E−01 | 1.918E−01 |
| C | −3.868E−01 | −1.022E+00 | 6.861E−01 | 7.186E−02 | −4.059E−01 | −1.396E−01 |
| D | 1.466E+00 | 3.090E+00 | −6.585E−01 | −9.608E−02 | 2.364E−01 | 6.310E−02 |
| E | −4.220E+00 | −6.259E+00 | 3.871E−01 | 5.679E−02 | −8.778E−02 | −1.787E−02 |
| F | 7.733E+00 | 8.075E+00 | −1.402E−01 | −1.826E−02 | 2.110E−02 | 3.131E−03 |
| G | −8.710E+00 | −6.365E+00 | 3.057E−02 | 3.309E−03 | −3.191E−03 | −3.200E−04 |
| H | 5.535E+00 | 2.786E+00 | −3.689E−03 | −3.166E−04 | 2.771E−04 | 1.667E−05 |
| J | −1.544E+00 | −5.192E−01 | 1.897E−04 | 1.240E−05 | −1.057E−05 | −3.107E−07 |

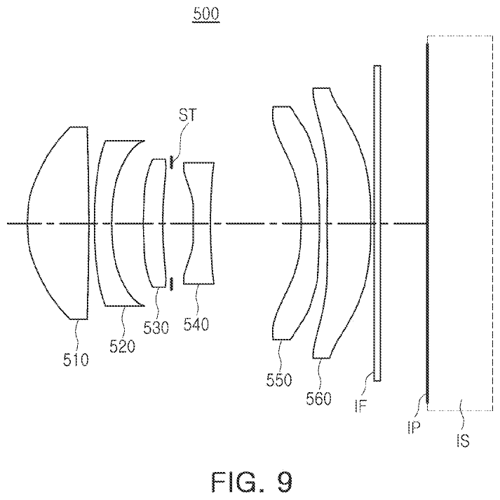

An imaging lens system according to a fifth example will be described with reference to FIG. 9.

An imaging lens system 500 includes a first lens 510, a second lens 520, a third lens 530, a fourth lens 540, a fifth lens 550, and a sixth lens 560.

The first lens 510 has positive refractive power, and has a convex object-side surface and a convex image-side surface. The second lens 520 has negative refractive power, and has a convex object-side surface and a concave image-side surface. The third lens 530 has negative refractive power, and has a convex object-side surface and a concave image-side surface. The fourth lens 540 has negative refractive power, and has a convex object-side surface and a concave image-side surface. The fifth lens 550 has negative refractive power, and has a concave object-side surface and a convex image-side surface. An inflection point is formed on the object-side surface and the image-side surface of the fifth lens 550. The sixth lens 560 has positive refractive power, and has a convex object-side surface and a convex image-side surface. An inflection point is formed on the object-side surface and the image-side surface of the sixth lens 560.

The imaging lens system 500 may further include a stop ST, a filter IF, and an imaging plane IP. The stop ST may be disposed between the third lens 530 and the fourth lens 540, and the filter IF may be disposed between the sixth lens 560 and the imaging plane IP. The imaging plane IP may be formed in a position in which light incident from the first lens 510 to the sixth lens 560 is formed. For example, the imaging plane IP may be formed on one surface of the image sensor IS of the camera module or inside the image sensor IS.

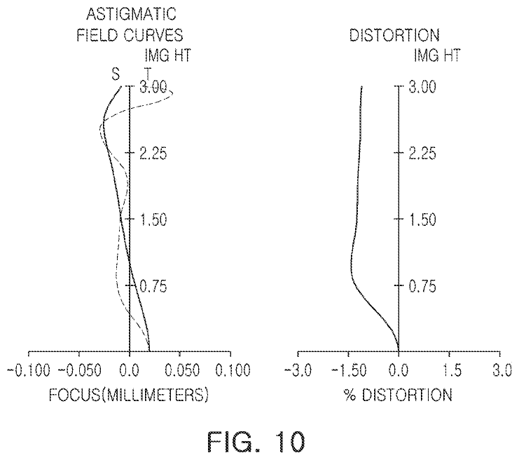

The imaging lens system 500 configured as above may exhibit aberration characteristics as illustrated in FIG. 10. Tables 9 and 10 illustrate lens characteristics and aspheric values of the imaging lens system 500.

TABLE 9

| Surface | | Radius of | Thickness/ | Refractive | Abbe |
|---|---|---|---|---|---|
| No. | Reference | curvature | distance | index | number |
| S1 | First lens | 1.99 | 1.034 | 1.544 | 56.0 |
| S2 | | −14.14 | 0.089 | | |
| S3 | Second lens | 7.50 | 0.280 | 1.680 | 18.2 |
| S4 | | 3.11 | 0.542 | | |
| S5 | Third lens | 9.39 | 0.310 | 1.535 | 55.7 |
| S6 | | 4.97 | 0.159 | | |
| S7 | Stop | Infinity | 0.365 | | |
| S8 | Fourth lens | 28.76 | 0.280 | 1.567 | 37.4 |
| S9 | | 4.28 | 1.525 | | |
| S10 | Fifth lens | −2.67 | 0.300 | 1.544 | 56.0 |
| S11 | | −35.84 | 0.119 | | |
| S12 | Sixth lens | 7.98 | 0.737 | 1.661 | 20.4 |
| S13 | | −13.20 | 0.050 | | |
| S14 | Filter | Infinity | 0.110 | 1.517 | 64.2 |
| S15 | | Infinity | 0.800 | | |
| S16 | Imaging | Infinity | −0.020 | | |
| | plane | | | | |

TABLE 10

| Surface No. | S1 | S2 | S3 | S4 | S5 | S6 |
|---|---|---|---|---|---|---|
| K | −1.476E−01 | −2.500E+01 | 1.754E+01 | 2.767E+00 | −3.139E+00 | −2.404E+01 |
| A | −2.260E−04 | −1.202E−02 | −5.897E−02 | −5.780E−02 | −6.146E−03 | −6.920E−02 |
| B | −3.584E−03 | 1.028E−01 | 1.536E−01 | 9.290E−02 | 8.658E−02 | 1.779E−01 |
| C | 7.125E−03 | −2.036E−01 | −1.985E−01 | 5.346E−02 | 1.021E−01 | −6.646E−01 |
| D | −1.038E−02 | 2.490E−01 | 1.777E−01 | −3.950E−01 | −5.232E−01 | 2.443E+00 |
| E | 7.697E−03 | −1.983E−01 | −7.844E−02 | 8.872E−01 | 1.137E+00 | −5.902E+00 |
| F | −3.240E−03 | 1.016E−01 | −1.369E−02 | −1.113E+00 | −1.516E+00 | 8.674E+00 |
| G | 7.129E−04 | −3.222E−02 | 3.235E−02 | 8.031E−01 | 1.231E+00 | −7.544E+00 |
| H | −6.618E−05 | 5.764E−03 | −1.361E−02 | −3.115E−01 | −5.475E−01 | 3.571E+00 |
| J | 5.397E−07 | −4.448E−04 | 1.952E−03 | 5.011E−02 | 9.869E−02 | −7.133E−01 |
| Surface No. | S8 | S9 | S10 | S11 | S12 | S13 |
| K | 2.500E+01 | 3.192E+00 | −2.500E+01 | −2.500E+01 | 7.403E+00 | 0.000E+00 |
| A | −3.092E−01 | −2.169E−01 | −4.986E−02 | −9.242E−02 | −2.585E−01 | −1.555E−01 |
| B | −5.194E−02 | 1.984E−01 | −3.891E−02 | 2.742E−01 | 4.888E−01 | 1.572E−01 |
| C | 7.945E−01 | −3.600E−01 | 3.679E−02 | −4.329E−01 | −5.365E−01 | −9.373E−02 |
| D | −2.621E+00 | 1.314E+00 | 4.205E−03 | 3.522E−01 | 3.461E−01 | 2.894E−02 |
| E | 5.179E+00 | −3.010E+00 | −1.945E−02 | −1.687E−01 | −1.390E−01 | −3.055E−03 |
| F | −5.943E+00 | 4.384E+00 | 1.209E−02 | 4.964E−02 | 3.534E−02 | −7.407E−04 |
| G | 3.549E+00 | −3.923E+00 | −3.633E−03 | −8.844E−03 | −5.548E−03 | 2.809E−04 |
| H | −7.369E−01 | 1.955E+00 | 5.532E−04 | 8.771E−04 | 4.921E−04 | −3.423E−05 |
| J | −1.104E−01 | −4.149E−01 | −3.420E−05 | −3.715E−05 | −1.892E−05 | 1.496E−06 |

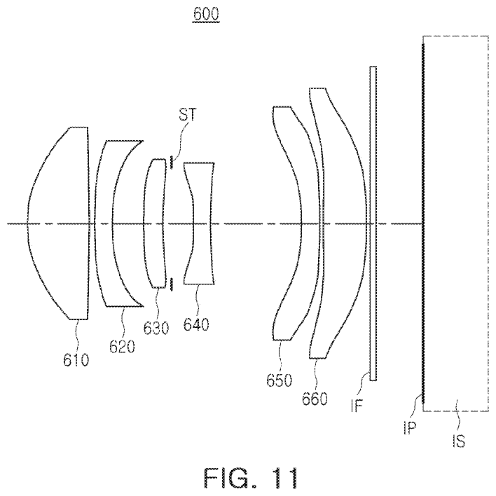

An imaging lens system according to a sixth example will be described with reference to FIG. 11.

An imaging lens system 600 includes a first lens 610, a second lens 620, a third lens 630, a fourth lens 640, a fifth lens 650, and a sixth lens 660.

The first lens 610 has positive refractive power, and has a convex object-side surface and a convex image-side surface. The second lens 620 has negative refractive power, and has a convex object-side surface and a concave image-side surface. The third lens 630 has negative refractive power, and has a convex object-side surface and a concave image-side surface. The fourth lens 640 has negative refractive power, and has a convex object-side surface and a concave image-side surface. The fifth lens 650 has negative refractive power, and has a concave object-side surface and a convex image-side surface. An inflection point is formed on the object-side surface and the image-side surface of the fifth lens 650. The sixth lens 660 has positive refractive power, and has a convex object-side surface and a convex image-side surface. An inflection point is formed on the object-side surface and the image-side surface of the sixth lens 660.

The imaging lens system 600 may further include a stop ST, a filter IF, and an imaging plane IP. The stop ST may be disposed between the third lens 630 and the fourth lens 640, and the filter IF may be disposed between the sixth lens 660 and the imaging plane IP. The imaging plane IP may be formed in a position in which light incident from the first lens 610 to the sixth lens 660 is formed. For example, the imaging plane IP may be formed on one surface of the image sensor IS of the camera module or inside the image sensor IS.

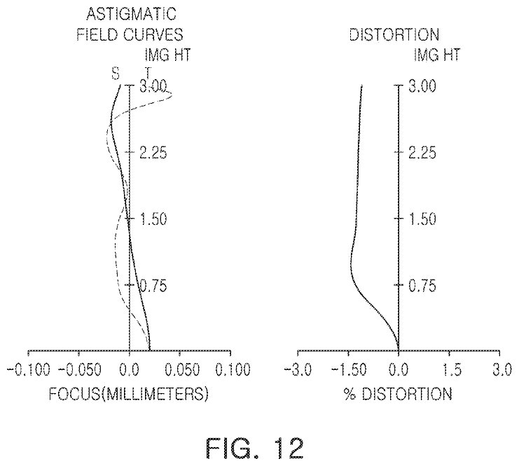

The imaging lens system 600 configured as above may exhibit aberration characteristics as illustrated in FIG. 12. Tables 11 and 12 illustrate lens characteristics and aspheric values of the imaging lens system 600.

TABLE 11

| Surface | | Radius of | Thickness/ | Refractive | Abbe |
|---|---|---|---|---|---|
| No. | Reference | curvature | distance | index | number |
| S1 | First lens | 1.99 | 1.048 | 1.544 | 56.0 |
| S2 | | −14.22 | 0.088 | | |
| S3 | Second lens | 7.46 | 0.280 | 1.680 | 18.2 |
| S4 | | 3.12 | 0.526 | | |
| S5 | Third lens | 8.05 | 0.325 | 1.535 | 55.7 |
| S6 | | 4.79 | 0.154 | | |
| S7 | Stop | Infinity | 0.361 | | |
| S8 | Fourth lens | 22.79 | 0.280 | 1.567 | 37.4 |
| S9 | | 3.79 | 1.523 | | |
| S10 | Fifth lens | −2.61 | 0.300 | 1.544 | 56.0 |
| S11 | | −28.40 | 0.070 | | |
| S12 | Sixth lens | 8.66 | 0.725 | 1.661 | 20.4 |
| S13 | | −13.70 | 0.050 | | |
| S14 | Filter | Infinity | 0.110 | 1.517 | 64.2 |
| S15 | | Infinity | 0.800 | | |
| S16 | Imaging | Infinity | −0.020 | | |
| | plane | | | | |

TABLE 12

| Surface No. | S1 | S2 | S3 | S4 | S5 | S6 |
|---|---|---|---|---|---|---|
| K | −1.467E−01 | −2.439E+01 | 1.746E+01 | 2.805E+00 | −4.390E+00 | −2.448E+01 |
| A | −6.624E−04 | −1.189E−02 | −5.902E−02 | −5.789E−02 | −5.471E−03 | −7.034E−02 |
| B | −1.525E−03 | 1.029E−01 | 1.531E−01 | 9.439E−02 | 8.209E−02 | 2.117E−01 |
| C | 1.882E−03 | −2.040E−01 | −1.980E−01 | 5.205E−02 | 1.041E−01 | −9.176E−01 |
| D | −2.316E−03 | 2.489E−01 | 1.795E−01 | −3.949E−01 | −5.002E−01 | 3.395E+00 |
| E | 1.164E−04 | −1.973E−01 | −8.433E−02 | 8.907E−01 | 1.043E+00 | −8.033E+00 |
| F | 1.169E−03 | 1.004E−01 | −6.191E−03 | −1.118E+00 | −1.333E+00 | 1.160E+01 |
| G | −8.362E−04 | −3.159E−02 | 2.738E−02 | 8.042E−01 | 1.031E+00 | −9.951E+00 |
| H | 2.354E−04 | 5.595E−03 | −1.190E−02 | −3.103E−01 | −4.329E−01 | 4.663E+00 |
| J | −2.449E−05 | −4.269E−04 | 1.711E−03 | 4.954E−02 | 7.206E−02 | −9.232E−01 |
| Surface No. | S8 | S9 | S10 | S11 | S12 | S13 |
| K | 1.585E+01 | 3.209E+00 | −2.500E+01 | 2.500E+01 | 9.506E+00 | 0.000E+00 |
| A | −3.120E−01 | −2.232E−01 | −2.039E−02 | −7.793E−02 | −2.798E−01 | −1.575E−01 |
| B | −4.220E−02 | 2.271E−01 | −1.372E−01 | 2.450E−01 | 5.460E−01 | 1.530E−01 |
| C | 7.842E−01 | −4.541E−01 | 1.978E−01 | −3.918E−01 | −6.199E−01 | −8.782E−02 |
| D | −2.533E+00 | 1.578E+00 | −1.454E−01 | 3.175E−01 | 4.153E−01 | 2.428E−02 |
| E | 4.801E+00 | −3.517E+00 | 6.417E−02 | −1.502E−01 | −1.733E−01 | −6.331E−04 |
| F | −5.128E+00 | 5.023E+00 | −1.680E−02 | 4.332E−02 | 4.574E−02 | −1.529E−03 |
| G | 2.565E+00 | −4.444E+00 | 2.444E−03 | −7.497E−03 | −7.439E−03 | 4.328E−04 |
| H | −1.056E−01 | 2.206E+00 | −1.639E−04 | 7.159E−04 | 6.818E−04 | −4.989E−05 |
| J | −2.768E−01 | −4.687E−01 | 2.312E−06 | −2.899E−05 | −2.702E−05 | 2.157E−06 |

Tables 13 and 14 illustrate optical characteristic values and conditional expressional values of the imaging lens system according to first to sixth examples.

TABLE 13

| | First | Second | Third | Fourth | Fifth | Sixth |
|---|---|---|---|---|---|---|
| Reference | example | example | example | example | example | example |
| f | 7.9399 | 7.9399 | 7.9396 | 7.9400 | 7.9400 | 7.9400 |
| f1 | 3.2375 | 3.2473 | 3.2119 | 3.1977 | 3.2734 | 3.2734 |
| f2 | −7.1474 | −7.0232 | −7.1525 | −7.0455 | −7.9365 | −7.9828 |
| f3 | −28.2519 | 275.9439 | −79.6779 | 199.9962 | −20.1312 | −22.7748 |
| f4 | −8.6949 | −6.2492 | −6.4853 | −5.7730 | −8.8366 | −8.0075 |
| f5 | −5.2372 | −5.2606 | −5.3064 | −5.4414 | −5.2946 | −5.2731 |
| f6 | 7.7228 | 7.3987 | 11.0446 | 11.9788 | 7.5493 | 8.0442 |
| TTL | 6.6800 | 6.6800 | 6.4698 | 6.4700 | 6.6800 | 6.6200 |
| BFL | 0.9400 | 0.9400 | 0.9398 | 0.9400 | 0.9400 | 0.9400 |
| f number | | 2.470 | | 2.470 | | |
| IMG HT | 3.000 | 3.000 | 3.000 | 3.000 | 3.000 | 3.000 |
| FOV | 41.975 | 41.923 | 41.910 | 41.959 | 41.952 | 41.958 |

TABLE 14

| Conditional | First | Second | Third | Fourth | Fifth | Sixth |
|---|---|---|---|---|---|---|
| expression | example | example | example | example | example | example |
| TTL/f | 0.84132 | 0.84132 | 0.81488 | 0.81486 | 0.84131 | 0.83375 |
| D34/TTL | 0.08241 | 0.07860 | 0.08307 | 0.08099 | 0.07847 | 0.07787 |
| f1/f | 0.40775 | 0.40899 | 0.40455 | 0.40273 | 0.41227 | 0.41227 |
| f4/f | −1.09508 | −0.78706 | −0.81682 | −0.72708 | −1.11292 | −1.00850 |
| V1-V2 | 35.61321 | 35.61321 | 35.61321 | 35.61321 | 37.83789 | 37.83789 |
| D12/f | 0.00674 | 0.00986 | 0.00637 | 0.00982 | 0.01123 | 0.01102 |
| BFL/f | 0.11839 | 0.11839 | 0.11837 | 0.11839 | 0.11839 | 0.11839 |
| D56/D12 | 2.22465 | 0.67064 | 0.98802 | 0.64138 | 1.33370 | 0.80425 |
| f/IMG HT | 2.64663 | 2.64663 | 2.64653 | 2.64667 | 2.64667 | 2.64667 |
| D23/D34 | 1.06936 | 1.19869 | 0.96135 | 1.08521 | 1.03478 | 1.02095 |
| D34/D45 | 0.37400 | 0.36039 | 0.38502 | 0.38807 | 0.34381 | 0.33849 |
| D45/f | 0.18538 | 0.18350 | 0.17582 | 0.17007 | 0.19202 | 0.19180 |
| D34/f | 0.06933 | 0.06613 | 0.06769 | 0.06600 | 0.06602 | 0.06492 |

As set forth above, according to the various examples, an imaging lens system that can be mounted in a thinned portable electronic device may be provided.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system, comprising:
a first lens comprising a convex image-side surface;
a second lens having refractive power;
a third lens having refractive power;
a fourth lens having refractive power;
a fifth lens having refractive power; and
a sixth lens having positive refractive power,
wherein the first lens to the sixth lens are sequentially disposed from an object side, and wherein
TTL/f≤0.85,
where TTL is a distance from an object-side surface of the first lens to an imaging plane, and f is a focal length of the imaging lens system.

2. The imaging lens system of claim 1, wherein the second lens has negative refractive power.

3. The imaging lens system of claim 1, wherein the fourth lens comprises a convex object-side surface.

4. The imaging lens system of claim 1, wherein the fourth lens comprises a concave image-side surface.

5. The imaging lens system of claim 1, wherein the fifth lens comprises a convex image-side surface.

6. The imaging lens system of claim 1, wherein the sixth lens comprises a convex object-side surface.

7. The imaging lens system of claim 1, wherein the sixth lens comprises a convex image-side surface.

8. The imaging lens system of claim 1, wherein
0.3<f1/f<0.5, where f1 is a focal length of the first lens.

9. The imaging lens system of claim 1, wherein
−3.0<f4/f<−0.1, where f4 is a focal length of the fourth lens.

10. The imaging lens system of claim 1, wherein
2.4<f/IMG HT<2.8, where IMG HT is a height of the imaging plane.

11. The imaging lens system of claim 1, wherein
0.1<BFL/f<0.25, where BFL is a distance from an image-side surface of the sixth lens to the imaging plane.

12. An imaging lens system, comprising:
a first lens, a second lens, a third lens, a fourth lens, a fifth lens, and a sixth lens, sequentially disposed from an object side, wherein
TTL/f≤0.85, and
0.30<D34/D45<0.40,
where TTL is a distance from an object-side surface of the first lens to an imaging plane, f is a focal length of the imaging lens system, D34 is a distance from an image-side surface of the third lens to an object-side surface of the fourth lens, and D45 is a distance from an image-side surface of the fourth lens to an object-side surface of the fifth lens.

13. The imaging lens system of claim 12, wherein the first lens comprises a convex image-side surface.

14. The imaging lens system of claim 12, wherein the sixth lens comprises a convex object-side surface.

15. The imaging lens system of claim 12, wherein
0.17<D45/f<0.20.

16. The imaging lens system of claim 12, wherein
0.063<D34/f<0.073.
